(19) United States
(12) Patent Application Publication
(10) Pub. No.: US 2007/0101114 A1
(43) Pub. Date: May 3, 2007

(54) Method and apparatus for memory initializing in a computer system

(76) Inventors: Masayuki Inoue, Kawasaki-shi (JP); Toshitaka Sanada, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/521,954

(22) Filed: Sep. 15, 2006

(30) Foreign Application Priority Data
Oct. 31, 2005 (JP) 2005-317178

(51) Int. Cl. G06F 15/177

(52) U.S. Cl. 713/1

(57) ABSTRACT

According to one embodiment, a memory module includes a RAM used to constitute a main memory and an SPD for storing first SPD data. A flash ROM is allocated to a memory space the CPU can access directly. A storing module reads out first SPD data from the SPD and stores the first SPD data as second SPD data into an SPD storage area of the flash ROM. A setting module, when the power supply of the personal computer is turned on, carries out an initial setting process for causing the RAM to function as a component element of the main memory on the basis of the SPD data stored in the SPD storage area.

### CROSS-REFERENCE TO RELATED APPLICATIONS

This application is based upon and claims the benefit of priority from Japanese Patent Application No. 2005-317178, filed Oct. 31, 2005, the entire contents of which are incorporated herein by reference.

### BACKGROUND

1. Field

One embodiment of the invention relates to a computer system and method, for example, to a memory initializing process.

2. Description of the Related Art

When the power supply of a personal computer is turned on, the Power-On Self-Test (POST) process of the system Basic Input Output System (BIOS) is generally executed.

In a conventional POST process, a memory initializing process is executed at the beginning of the POST process. In the memory initializing process, first, a memory recognizing process is carried out. In the memory recognizing process, the system BIOS reads Serial Presence Detect (SPD) data stored in the SPD included in a memory module. The SPD is a nonvolatile memory which stores SPD data, such as an EEPROM. The memory module includes a RAM used to constitute a main memory. On the basis of the SPD data read from the SPD, the system BIOS carries out an initial setting process for causing a RAM installed in the memory module to function as a component element of the main memory.

There is conventional technology using SPD data. In the conventional technology, when the power supply of a personal computer is turned on, the SPD data stored in the memory module, such as a Dual In-line Memory Module (DIMM), is copied into a flash ROM connected to the memory module. Then, the SPD data stored in the memory module is erased. That is, the SPD data stored in the memory module is moved to a flash memory of the computer body (refer to Jpn. Pat. Appln. KOKAI Publication No. 2000-148600).

As a result, if the memory module is taken out without notice and used in another computer, the other computer operates abnormally. That is, it is impossible to use the memory module in another computer. Consequently, it is possible to prevent the memory module from being stolen.

As described above, in the conventional technology, when the power supply of the personal computer is turned on, the SPD data stored in the memory module is moved from the memory module to the flash ROM. Moreover, in the conventional technology, the memory initializing process is carried out on the basis of the SPD data moved to the flash ROM.

In the conventional technology, however, no consideration has been given to speeding up the memory initializing process.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a system configuration of a personal computer according to an embodiment of the present invention;

FIG. 2 shows an example of memory mapping a memory space a CPU can access directly in the embodiment; and

FIG. 3 is an exemplary flowchart to help explain the procedure for a memory initializing process applied to the embodiment.

### DETAILED DESCRIPTION

Various embodiments according to the invention will be described hereinafter with reference to the accompanying drawings. In general, according to one embodiment of the invention, there is provided a computer system with a CPU for executing various programs, comprising: a memory module which includes a RAM used to constitute a main memory and a first nonvolatile memory for storing first SPD data which represents the specifications of the memory module; a second nonvolatile memory which is allocated to a memory space the CPU is capable of accessing directly; a first control unit which reads out the first SPD data from the first nonvolatile memory and stores the first SPD data as second SPD data into a specific area of the second nonvolatile memory; and a second control unit which carries out an initial setting process for, when the power supply of the computer system is turned on, causing the RAM installed in the memory module to function as a component element of the main memory on the basis of the second SPD data stored in the specific area of the second nonvolatile memory.

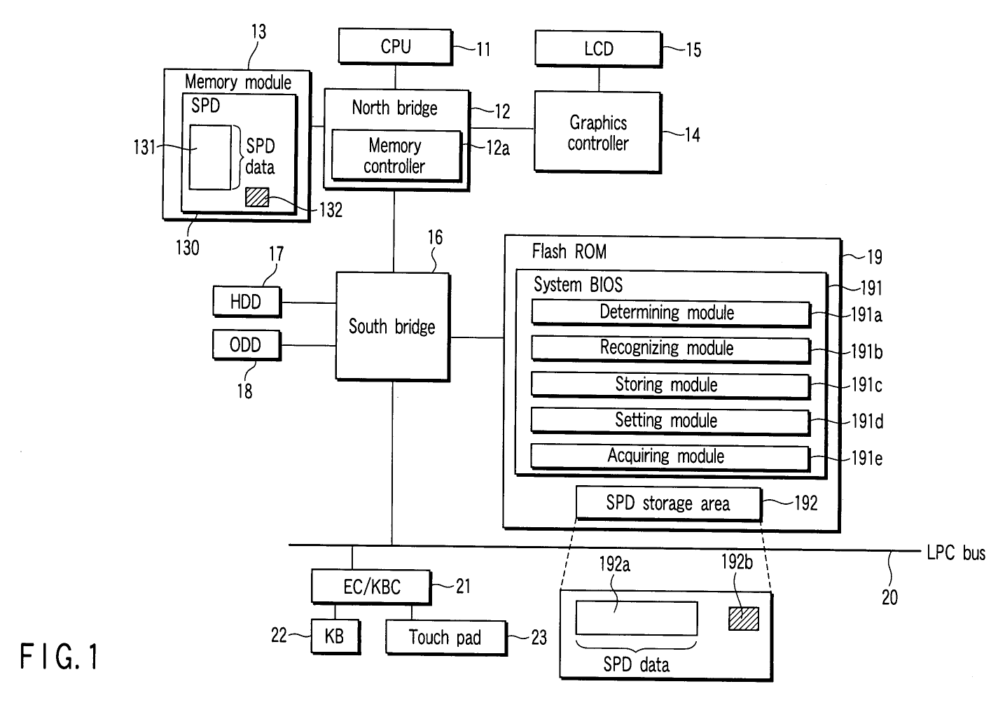

Referring to FIG. 1, the configuration of a computer system according to an embodiment of the present invention will be explained. The computer system is realized in the form of, for example, a notebook personal computer. FIG. 1 is a block diagram showing the configuration of a notebook personal computer. The personal computer comprises a CPU 11, a north bridge 12, a memory module 13, a graphics controller 14, a south bridge 16, a hard disk drive (HDD) 17, an optical disk drive (ODD) 18, a flash ROM 19, and an embedded controller/keyboard controller (EC/KBC) IC 21.

The CPU 11 is a processor provided to control the operation of the computer. The CPU 11 executes not only an operating system (OS) which carries out integrated management of the allocation of hardware resources and software resources in the computer but also various application programs, including a video replay application program. The OS and various application programs are loaded from the hard disk drive (HDD) 17 into a main memory (not shown) explained later. Moreover, the CPU 11 executes a system Basic Input Output System (BIOS) 191 stored in the flash ROM 19.

The north bridge 12 is a device which connects a local bus of the CPU 11 and the south bridge 16. The north bridge 12 houses a memory controller 12a which controls access to the memory module 13. The north bridge 12 has the function of communicating with the graphics controller 14 via an accelerated graphics port (AGP) or the like.

The memory module 13 includes a RAM, such as a dynamic RAM (DRAM), which is used to constitute the main memory. The memory module 13 further includes a Serial Presence Detect (SPD) 130. The SPD 130 is a nonvolatile memory (a first nonvolatile memory), such as an EEPROM. The SPD 130 has an SPD data area 131 in which first SPD data is stored. The SPD data is data representing the specifications of the memory module 13, including the capacity, access rate, access method, and memory configuration of the memory module 13. The SPD 130 further has a flag storage area 132 in which a first SPD data storage flag (flag information) explained later is written.

The graphics controller 14 is a display controller which controls an LCD 15 used as a display monitor of the computer. The graphics controller 14 displays the video data written in a video memory (VRAM) on the LCD 15.

The south bridge 16 controls each device on a Low Pin Count (LPC) bus 20 and each device on a Peripheral Component Interconnect (PCI) bus (not shown). In addition, the south bridge 16 houses an Integrated Drive Electronics (IDE) controller for controlling the HDD 17 and ODD 18. Moreover, the south bridge 16 has the function of controlling access to the flash ROM 19 (a second nonvolatile memory).

The HDD 17 is a storage unit which stores various types of software and data. The ODD 18 is a drive unit for driving storage media, including CD media and DVD media in which video contents or the like have been stored.

The EC/KBC 21 is a single-chip microcomputer into which an embedded controller (EC) for power management and a keyboard controller for controlling a keyboard (KB) 22 and a touchpad 23 have been integrated. The EC/KBC 21 has the function of turning on and off the power supply of the computer according to the user's operation of the power button.

The flash ROM 19 is a rewritable nonvolatile memory. The flash ROM 19 is allocated to a memory space the CPU 11 can access directly. The main memory is also allocated to the memory space. The flash ROM 19 stores a system BIOS 191. The flash ROM 19 further has an SPD storage area 192. The SPD storage area 192 includes an SPD data storage area 192a which stores the SPD data stored in the SPD data area 131 of the SPD 130. Moreover, the SPD storage area 192 includes a flag storage area 192b which stores a second SPD data storage flag.

Here, the SPD data storage flag will be explained. The flag is information unique to the memory module and personal computer. The flag is used to determine whether the first SPD data stored in the SPD data area 131 included in the SPD 130 of the memory module 13 has been stored as the second SPD data in the flash ROM 19. That is, the flag is used to determine whether the memory module 13 has been replaced with another memory module. The flag is written as the first SPD data storage flag into the flag storage area 132 of the SPD 130 by the system BIOS 191. Moreover, the flag is written as the second SPD data storage flag into the flag storage area 192b of the flash ROM 19 by the system BIOS 191.

The system BIOS 191 is a program for hardware control. The CPU 11 executes the system BIOS 191, thereby realizing hardware control. In the explanation below, however, to avoid complications, suppose the system BIOS 191 performs hardware control.

The system BIOS 191 includes a determining module 191a, a recognizing module 191b, a storing module 191c, a setting module 191d, and an acquiring module 191e.

The determining module 191a, when the power supply of the personal computer is turned on, reads in the first and second SPD data storage flags written in the flag storage areas 132 and 192b, respectively. In addition, the determining module 191a determines whether the read-in flags coincide with each other. On the basis of whether the flags coincide with each other, the determining module 191a determines whether the memory module 13 has been replaced with another one. Moreover, the determining module 191a has the function of determining whether the second SPD data has been stored in the SPD data storage area 192a.

The recognizing module 191b reads in the first SPD data stored in the SPD data area 131 of the SPD 130. In addition, the recognizing module 191b acquires memory configuration information and others from the read-in first SPD data.

The storing module 191c writes the first SPD data stored in the SPD data area 131 of the SPD 130 as the second SPD data into the SPD data storage area 192a of the flash ROM 19. At this time, the storing module 191c writes the SPD data storage flag as the first and second SPD data storage flags into the flag storage areas 132 and 192b.

On the basis of the first or second SPD data, the setting module 191d performs on the memory controller 12a an initial setting process for causing the RAM installed in the memory module 13 to function as a component element of the main memory.

The acquiring module 191e reads in the second SPD data written in the SPD data storage area 192a. The acquiring module 191e acquires memory configuration information and others from the read-in SPD data.

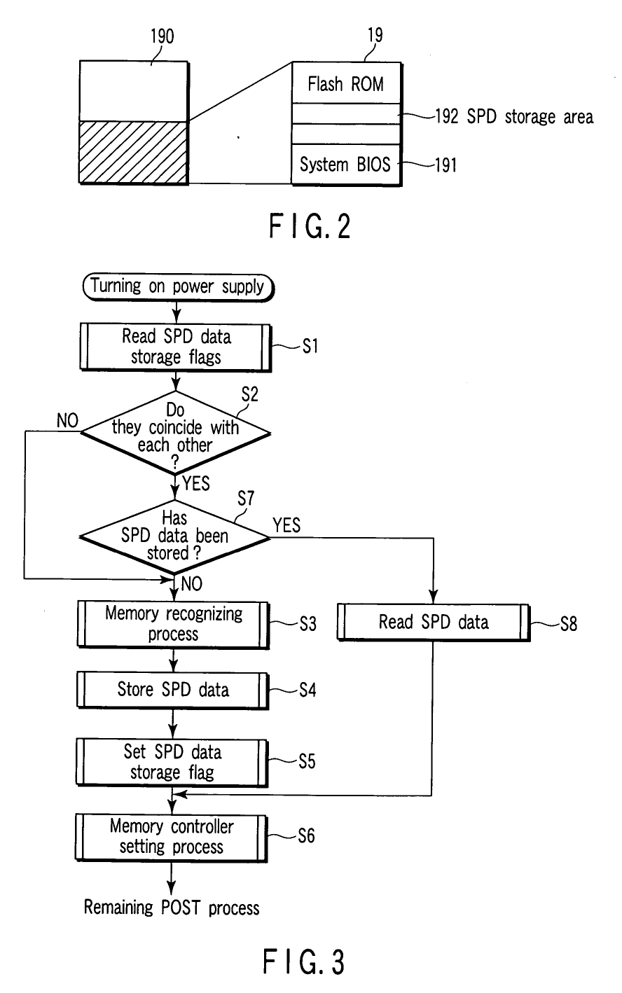

FIG. 2 shows an example of memory mapping the memory space 190 the CPU 11 can access directly. The flash ROM 19 has been allocated to the memory space 190. That is, the system. BIOS 191 and SPD storage area 192 are allocated to the memory space 190. This makes it possible to read at high speed the second SPD data stored in the SPD data storage area 192a included in the SPD storage area 192.

Next, referring to the flowchart of FIG. 3, the procedure for the memory initializing process will be explained.

When the power supply of the personal computer of FIG. 1 is turned on, the system BIOS 191 carries out a Power-On Self-Test (POST) process. The memory initializing process is carried out at the beginning of the POST process.

In the memory initializing process, the determining module 191a first reads in the first and second SPD data storage flags from the flag storage areas 132 and 192b, respectively (step S1). The determining module 191a compares the read-in two flag and determines whether they coincide with each other (step S2). For example, as in a case where the personal computer of FIG. 1 is started up for the first time, if the first and second SPD data storage flags have not been stored in the flag storage areas 132 and 192b, the determining module 192a determines that they do not coincide with each other. As described later, when the memory module 13 has been replaced, the determining module 192a determines that they do not coincide with each other.

Now, suppose the determining module 192a has determined that they do not coincide with each other. In this case, the recognizing module 191b carries out a memory recognizing process explained later (step S3). First, the recognizing module 191b reads in the first SPD data stored in the SPD data area 131 of the SPD 130. The first SPD data is read in a specific protocol using the SPD 130 as one of the input/output devices. Therefore, it is difficult to read the first SPD data at high speed. The recognizing module 191b acquires memory configuration information and others from the read-in first SPD data, thereby recognizing the configuration and the like of the memory module 13.

After the recognizing module 191b executes step S3, the storing module 191c is started up. The storing module 191c writes the first SPD data read from the SPD data area 131 of the SPD 103 by the recognizing module 191b as the second SPD data into the SPD data storage area 192a included in the SPD storage area 192 of the flash ROM 19 (step S4). The state where the first SPD data stored in the SPD data area 131 of the SPD 130 has been stored as the second SPD data in the SPD data storage area 192a of the flash ROM 19 is referred to as a first state and a state other than this is referred to as a second state.

Next, the storing module 191c generates an SPD data storage flag and writes it as a first and a second SPD data storage flag into the flag storage area 132 of the SPD 130 and the flag storage area 192b of the flash ROM 19, respectively (step S5). Here, the SPD data storage flag is unique information based on a combination of the personal computer on which the system BIOS 191 including the storing module 191c is installed and the memory module 13 installed in the personal computer.

After step S4 and step S5 are executed by the storing module 191c, the setting module 191d is started up. The setting module 191d carries out an initial setting process for initializing the memory controller 12a on the basis of the SPD data (here, the first SPD data) previously read by the recognizing module 191b (step S6). By the initial setting process, the optimum operation condition for causing the RAM installed in the memory module 13 to function as the main memory is set in the memory controller 12a.

After the initial setting process in step S6 has been carried out, the memory initializing process is completed, followed by the execution of the remaining POST process. After the POST process is completed, the system BIOS 191 stored in the flash ROM 19 is loaded into a specific area of the main memory. The CPU 11 executes the system BIOS 191 loaded in the main memory.

Suppose, in this state, the power supply of the personal computer of FIG. 1 is turned off and then the power supply is turned on again. In this case, the memory initializing process is started. Then, the determining module 191a reads in the first and second SPD data storage flags from the flag storage areas 132 and 192b, respectively (step S1). The determining module 191a determines whether the read-in two flags concede with each other (step S2).

As described above, in the personal computer of FIG. 1, step S1 to step S6 have been carried out in the memory initializing process in the preceding turning on of the power supply. In the initializing process (step S5), the second SPD data storage flag is written into the flag storage area 192b. Therefore, at present, the second SPD data storage flag is stored in the flag storage area 192b.

Here, it is assumed that the memory module 13 has not been replaced during the time from the preceding turning on of the power supply to the present turning on of the power supply. In this state, the first SPD data storage flag written in the flag storage area 132 in the memory initializing process in the preceding turning on of the power supply (step S5) has been stored in the flag storage area 132. Accordingly, in step S2 of the present initializing process, the determining module 191a determines that they coincide with each other. In this case, the determining module 191a determines that the memory module 13 has not been replaced during the time from the preceding turning on of the power supply to the present turning on of the power supply.

At this time, for example, if there is no abnormality or the like in the flash ROM 19, the first SPD data stored in the SPD 130 of the memory module 13 should be stored as the second SPD data in the SPD data storage area 192a of the flash ROM 19. Thus, the determining module 191a determines whether the second SPD data has been stored in the SPD data storage area 192a (step S7).

As described above, if it has been determined in step S2 that the two SPD data storage flags coincide with each other and it has been determined in step S7 that the second SPD data has been stored in the SPD data storage area 192a, that is, if the first state has been determined, the acquiring module 191e executes a memory recognizing process explained later (step S8). First, the acquiring module 191e reads the second SPD data from the SPD data storage area 192a. Here, the flash ROM 19 including the SPD data storage area 192a has been allocated to the memory space the CPU 11 can access directly. Therefore, the acquiring module 191e can read the second SPD data from the SPD data storage area 192a at high speed. The acquiring module 191e acquires memory configuration information and others from the read-in second SPD data and recognizes the configuration and the like of the memory module 13.

After the acquiring module 191e has executed step S8, the setting module 191d is started up. Unlike in step S6, the setting module 191d executes step S6 (initial setting process) on the basis of the SPD data (here, the second SPD data) read by the acquiring module 191e in step S8.

Even when the first and second SPD data storage flags have been stored in the flag storage areas 132 and 192b respectively and it has been determined that the two flags coincide with each other, it is possible that the second SPD data stored in the SPD data storage area 192a will disappear for some reason. If the second SPD data is lost in the SPD data storage area 192a, the decision is No in Step S7. In this case, as when it is determined that the two flags do not coincide with each other, the processes in step S3 to step S6 are carried out.

Next, after the power supply of the personal computer has been turned off, the memory module 13 is replaced with another memory module. Thereafter, when the power supply of the personal computer is turned on again, a memory initializing process is carried out. This memory initializing process will be explained below. Hereinafter, the memory module 13 before replacement is referred to as the old memory module 13 and the memory module after replacement is referred to as the new memory module 13.

First, the determining module 191a reads the first and second SPD data storage flags from the flag storage areas 132 and 192b, respectively (step S1). Next, the determining module 191a determines whether the read-in two flags coincide with each other (step S2).

At present, in the flag storage area 192b, the second SPD data storage flag unique to the old memory module 13 and the personal computer of FIG. 1 has been stored by the memory initializing process executed when the power supply was turned on last. In the SPD data storage area 192a, the first SPD data stored in the SPD data area 131 included in the SPD 130 of the old memory module 13 has been stored as the second SPD data. When the old memory module 13 is replaced, the type of the new memory module 13 generally differs from that of the old memory module 13.

Here, suppose step S8 is carried out in the initializing process, although the old memory module 13 has been replaced with the new memory module 13. In this case, SPD data different from the SPD data stored in the SPD 130 of the new memory module 13, that is, the SPD data stored in the SPD 130 of the old memory module 13, is read. As a result, a proper memory initializing process will not be carried out. In the embodiment, to overcome this problem, whether the memory module has been replaced is determined as follows.

First, suppose the new memory module 13 to be substituted for the old memory module 13 has been provided for a personal computer different from the personal computer of FIG. 1. Moreover, suppose the first SPD data storage flag has been stored in the flag storage area 132 of the new memory module 13. The first SPD data storage flag differs from the first SPD data storage flag stored in the flag storage area 132 of the old memory module 13. Therefore, in step S2 of the present initializing process, the determining module 191a determines that the two flags do not coincide with each other. In this case, the determining module 191a can determine that the old memory module 13 has been replaced with the new memory module 13.

Next, it is assumed that, since the new memory module 13 is, for example, unused, a valid first SPD data storage flag has not been stored in the flag storage area 132 of the new memory module 13. In this case, too, since it has been determined in step S2 that the two flags do not coincide with each other, the determining module 191a can determine that the old memory module 13 has been replaced with the new memory module 13.

If it has been determined in step 2 that the two flags do not coincide with each other, that is, if it has been determined that the old memory module 13 has been replaced with the new memory module 13, the second state is determined. In this case, the processes in step S3 to step S6 are executed.

As described above, the memory initializing process can be executed at high speed by executing the memory initializing process on the basis of not the first SPD data stored in the SPD 130 of the memory module 13 but the second SPD data stored in the SPD storage area 192 of the flash ROM 19 allocated to the memory space the CPU 11 can access directly.

Furthermore, if the old memory module 13 is replaced with the new memory module 13 and a memory initializing process reads the SPD data which was read out from the SPD data area 131 of the old memory module 13 and stored in SPD storage area 192 of the flash ROM 19, the memory initializing process is not carried out proper. However, in the embodiment, by referring to the SPD data storage flags written in the flag storage area 132 of the memory module 13 and the flag storage area 192b of the flash ROM 19, it is possible to determine whether the memory module 13 has been replaced. Accordingly, if the old memory module 13 has been replaced with the new memory module 13, the memory initializing process is carried out on the basis of the SPD data stored in the SPD data storage area 131 of the new memory module 13.

Therefore, according to the embodiment, it is possible to prevent the memory initializing process from being carried out on the basis of the SPD data in the old memory module 13, although the old memory module 13 has been replaced with the new memory module 13.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A computer system with a CPU for executing various programs, comprising:
a memory module which includes a RAM used to constitute a main memory and a first nonvolatile memory for storing first SPD data which represents the specifications of the memory module;
a second nonvolatile memory which is allocated to a memory space the CPU is capable of accessing directly;
a first control unit which reads out the first SPD data from the first nonvolatile memory and stores the first SPD data as second SPD module into a specific area of the second nonvolatile memory; and
a second control unit which carries out an initial setting process for, when the power supply of the computer system is turned on, causing the RAM installed in the memory module to function as a component element of the main memory on the basis of the second SPD data stored in the specific area of the second nonvolatile memory.

2. The computer system according to claim 1, further comprising:
a third control unit which, when the power supply of the computer system is turned on, determines whether the first SPD data stored in the first nonvolatile memory of the memory module coincides with the second SPD data stored in the specific area of the second nonvolatile memory,
wherein, if the first SPD data does not coincide with the second SPD data, the second control unit carries out the initial setting process on the basis of the first SPD data.

3. The computer system according to claim 1, further comprising:
a third control unit which, when the power supply of the computer system is turned on, determines whether the first SPD data stored in the first nonvolatile memory of the memory module has been stored as the second SPD data in the second nonvolatile memory,
wherein the second control unit carries out the initial setting process on the basis of the second SPD data in a first state where the first SPD data stored in the first nonvolatile memory has been stored as the second SPD data in the second nonvolatile memory, and carries out the initial setting process on the basis of the first SPD data in a second state where the first SPD data stored in the first nonvolatile memory has not been stored as the second SPD data in the second nonvolatile memory, and
the first control unit, if the second state is satisfied, stores the first SPD data stored in the first nonvolatile memory as the second SPD data into the specific area of the second nonvolatile memory.

4. The computer system according to claim 3, wherein the first control unit stores the same flag information into a specific area of each of the first and second nonvolatile memories, when storing the first SPD data stored in the first nonvolatile memory of the memory module as the second SPD data into the specific area of the second nonvolatile memory, and
the third control unit, when the power supply of the computer system is turned on, compares the first flag information and second flag information stored in the first and second nonvolatile memories respectively, and if the first flag information and second flag information coincide with each other and the second SPD data has been stored in the second nonvolatile memory, determines the first state, and if they do not coincide with each other or the second SPD data has not been stored in the second nonvolatile memory, determines the second state.

5. The computer system according to claim 4, wherein the flag information is information unique to a combination of the computer system and the memory module.

6. The computer system according to claim 3, wherein the second nonvolatile memory stores a BIOS the CPU is capable of executing, the BIOS including the first control unit, the second control unit, and the third control unit.

7. A method of initializing a memory applied to a computer system which has a CPU for executing various programs, a memory module which includes a RAM used to constitute a main memory and a first nonvolatile memory for storing first SPD data which represents the specifications of the memory module, and a second nonvolatile memory which is allocated to a memory space the CPU is capable of accessing directly, the method comprising:
storing the first SPD data read out from the first nonvolatile memory as second SPD data into a specific area of the second nonvolatile memory; and
carrying out an initial setting process for causing the RAM included in the memory module to function as a component element of the main memory on the basis of the second SPD data stored in the specific area of the second nonvolatile memory, when the power supply of the computer system is turned on.

8. The method according to claim 7, further comprising:
determining whether the first SPD data stored in the first nonvolatile memory of the memory module has been stored as the second SPD data in the second nonvolatile memory, when the power supply of the computer system is turned on,
wherein the step of carrying out the setting process is to carry out the initial setting process on the basis of the first SPD data, when the first SPD data has not been stored as the second SPD data in the second nonvolatile memory.
